(19) United States
(12) Patent Application Publication
(10) Pub. No.: US 2014/0319289 A1
(43) Pub. Date: Oct. 30, 2014

(54) MOUNTING SYSTEM

(71) Applicant: CASTEL ENGINEERING SA, Mouscron (BE)

(72) Inventor: Jean-Claude CASTELEIN, KORTRIJK (BE)

(21) Appl. No.: 13/941,080

(22) Filed: Jul. 12, 2013

(51) Int. Cl. F16L 3/12

(52) U.S. Cl. CPC F16L 3/12
USPC 248/68.1

(57) ABSTRACT

A mounting system (1) for mounting tubes of a climatization device comprising a section (2) and a mounting element (3) for fixating the tubes to the mounting system (1) wherein the mounting element (3) is turnable, substantially parallel with respect to the bottom (12) of the section (2), from a first position, in which the mounting element (3) is connected to the section (2), to a second position, in which the mounting element (3) can be detached from the section (2) and vice versa.

### BACKGROUND

In order to keep the tubes of a climatization device or a refrigeration device out of sight and also for mounting and for protecting these tubes, it is common practice to use one or several ducts with associated mounting elements, wherein these ducts are attached to a surface, for example a wall. The mounting elements are detachably connected to the ducts and the tubes are connected to the mounting elements by cable ties, a snap connecting etc. as such to mount the tubes inside the duct and to keep them out of sight, to protect them and to keep them in place.

These ducts comprise a bottom and a first and a second L-shaped protrusion, protruding from said bottom and extending in the longitudinal direction of the duct over the entire length of the duct, wherein between the bottom and each protrusion a U-shaped mounting channel is located. The mounting elements comprise a rectangular base and a first and a second L-shaped protruding connecting part, protruding from parallel sides of said base, wherein each connecting part comprises a flange. When the mounting element is connected to the duct, the first protrusion interlocks with the first connecting part and the second protrusion interlocks with the second connecting part, as such that each flange of the mounting element is partially located inside the respective mounting channel.

These mounting elements are slidable in the longitudinal direction of the duct with respect to the duct and these mounting elements are connected to the ducts by sliding the flanges of the mounting elements into the mounting channels. This sliding of the flanges into the mounting channels, the connecting of the mounting element to the duct, can only take place at the edges of the protrusions/duct, as seen in the longitudinal direction. After the mounting element is connected to the duct, the mounting element needs to be slid to the desired location with respect to the duct. To disconnect the mounting element, the mounting element should be slid to an edge of the duct.

In most cases, it is desired that the ducts have a certain length. Since the mounting elements are fitted on the edge of the ducts, the mounting elements often need to be slid over a certain length to put them on the desired location with respect to the duct. This is time consuming. Often several ducts are attached next to each other against a surface. When each side of a duct rests against another duct, the mounting elements cannot be fitted directly onto that duct, often the outer ducts are also not accessible for the mounting elements. Therefore the mounting elements need to be connected to the ducts before they are attached to a surface. Often, initially, it is not known how much mounting elements are needed. If it becomes apparent that there are not enough mounting elements or too much mounting elements placed on the ducts after they are attached to the surface, this is a problem, because this means that some ducts will need to be removed again. This is of course time consuming. If after a certain period of time, a mounting element brakes, a duct needs to be removed to be able to replace the broken mounting element. This is time consuming.

### SUMMARY

It is therefore an object of the invention to solve the abovementioned problem and to provide a mounting system in which the connection and disconnection of the mounting element is simpler, less time consuming and can take place after the ducts are attached to a surface.

Embodiments of the present invention relate to a mounting system for mounting tubes of a climatization device or a refrigeration device, wherein this mounting system comprises a section and a mounting element for fixating the tubes to the mounting system wherein the section comprises
a bottom;
at least one protrusion protruding from said bottom;
a first and a second mounting channel, in which said mounting channels are at least partially delimited by a said protrusion;
   wherein the mounting element is detachably connectable to the section, wherein the mounting element comprises
a base;
a first and a second protruding connecting part protruding form said base;
   wherein each connecting part comprises a flange for detachably connecting the mounting element to the section, wherein, when the mounting element is connected to the section, the first and the second flange of the mounting element are respectively at least partially located inside said first and said second mounting channel, and wherein the mounting element is turnable, substantially parallel with respect to the bottom of the section, from a first position to a second position and vice versa, in which in the first position, the flanges of the mounting element are at least partially located inside the mounting channels, and the mounting element is connected to the section and in which in the second position, the flanges of the mounting element are located outside the mounting channels as such to allow the mounting element to be detached from the section.

Because these mounting elements are turnable, substantially parallel with respect to the bottom of the section, from said first position to said second position, these mounting elements can be connected to or disconnected from the section even if several sections are placed next to each other and even if one or several sections are attached to a surface. The connecting and disconnecting is also simple and consumes less time, because the mounting elements can directly be fitted onto the desired location of the section. If it becomes apparent that there are not enough mounting elements or too much mounting elements placed on the sections after they are attached to the surface, additional mounting elements can simply be fitted onto the sections or mounting elements can simply be disconnected from the sections without the need to remove one or several sections from the surface. It is also simple to replace a broken mounting element.

In a specific embodiment the mounting element comprises a first and a second mounting gutter which are respectively enclosed between the first protruding connecting part and the base and between the second protruding connecting part and the base, and the section comprises at least two protrusions, wherein each protrusion comprises a flange wherein, in the first position of the mounting element, the flange of the first protrusion is partially located inside the first mounting gutter and the flange of the second protrusion is partially located inside the second mounting gutter. The protrusions and the connecting parts interlock when the mounting element is connected to the section, making this a very strong connection.

In this specific embodiment the section may comprise two protrusions at a certain distance from each other and parallel with each other, which are L-shaped beams and which extend in the longitudinal direction of the section. A section with L-shaped beams is easy to manufacture. For example a section made of plastic can be produced by means of extrusion, a section made of metal can be produced by means of extrusion, folding or rolling. Because of the L-shaped beams, the mounting channels are UI-shaped and very suitable for connecting the mounting element to them.

In another specific embodiment the mounting element comprises a first and a second mounting gutter which are respectively enclosed between the first protruding connecting part and the base and between the second protruding connecting part and the base, and the protrusion comprises two flanges, wherein in the first position of the mounting element, the first flange of the protrusion is partially located inside the first mounting gutter and the second flange of the protrusion is partially located inside the second mounting gutter. Also this embodiment brings about a very strong connection, because the protrusion and the connecting parts interlock when the mounting element is connected to the section.

In this specific embodiment the protrusion may be a T-shaped beam which extends in the longitudinal direction of the section. A section with a T-shaped beam is easy to manufacture. For example a section made of plastic can be produced by means of extrusion, a section made of metal can be produced by means of extrusion, folding or rolling. Because of the T-shaped beam, the mounting channels are U-shaped and very suitable for connecting the mounting element to them.

In an embodiment, the first and the second mounting channel extend in the longitudinal direction of the section and run substantially parallel to each other, and each mounting channel has the same cross section, perpendicular to said longitudinal direction, throughout its entire length. Because of this, the mounting elements can be standardized and each mounting element can be connected to the section at the desired location with respect to the section.

The cross section of the flanges of the connecting parts, parallel with respect to the base, may have substantially a trapezoidal shape as such that when the mounting element is in its first position, the parallel sides of said trapezoid run substantially parallel to the mounting channels and as such that when the mounting element is in its second position the lateral side of said trapezoid closest to a said mounting channel runs substantially parallel to the mounting channels. With this particular shape of the flanges, a relative large part of the flanges is located inside said first and said second mounting channel when the mounting element is in its first position, without compromising the ability of the mounting element to turn, substantially parallel with respect to the bottom of the section, from its first position to its second position and vice versa. This shape is also easy to manufacture.

In embodiments, the flanges of the connecting parts are located at opposite sides of the mounting element as far apart as possible. The mounting element is connected to the section by means of the connecting parts. Since these connecting parts are located at opposite sides of the mounting element as far apart as possible, the mounting element is strongly connected to the section.

The section may be a duct. Ducts with associated mounting elements are commonly used and very suitable for keeping the tubes of a climatization device or a refrigeration device out of sight and also for mounting and for protecting these tubes.

In an embodiment the mounting element comprises a blocking element for blocking the mounting element, which is movably connected to the base as such that the blocking element is movable from a home position to a second position with respect to the base, wherein this blocking element comprises a projection, located on the same side of the mounting element as the connecting parts as such that during the turning of the mounting element from its second position to its first position, the projection slides over the protrusion, thereby at first pushing the blocking element upwards form its home position to is second position, and afterwards the blocking element returns to its home position as such blocking the mounting element in its first position. This blocking element ensures that a certain force is required, to move the mounting element from its first position (the position where it is connected to the section) and its second position (the position where it can be detached from the section). The connecting between the mounting element and the section cannot just loosen during the use of the mounting system. Human intervention is required to disconnect the mounting element from the section. Of course, other types of blocking elements are also possible.

In embodiments, the mounting element comprises two blocking elements at opposite sides of the mounting element as far away as possible. This ensures even better that the mounting element does not disconnect from the section during the use of the mounting system.

In embodiments, the tubes are connected to the mounting element by a cable tie. However other connections such as snap connections are also possible. The mounting element may also be slidable with respect to the protrusion so the mounting element can be easily slid to another location with respect to the section, once the mounting element is connected to the section.

In embodiments, the mounting element is created as one piece. Because of this, the different components cannot easily loosen. The mounting element can be manufactured for example by means of injection molding.

### BRIEF DESCRIPTION OF THE DRAWINGS

FIG. 1 presents a side view of a section according to the invention, in an embodiment;

FIG. 2 presents a side view of a mounting system according to the invention, in an embodiment, comprising a section as illustrated in FIG. 1;

FIG. 3 presents a view in perspective of the mounting element illustrated in FIG. 2;

FIG. 4 presents a top view of the mounting element illustrated in FIG. 3;

FIG. 5 presents a bottom view of the mounting element illustrated in FIGS. 3 and 4;

FIG. 6 presents a side view of the mounting element illustrated in FIGS. 3 to 5;

FIG. 7 presents a detailed view of the encircled portion of FIG. 6;

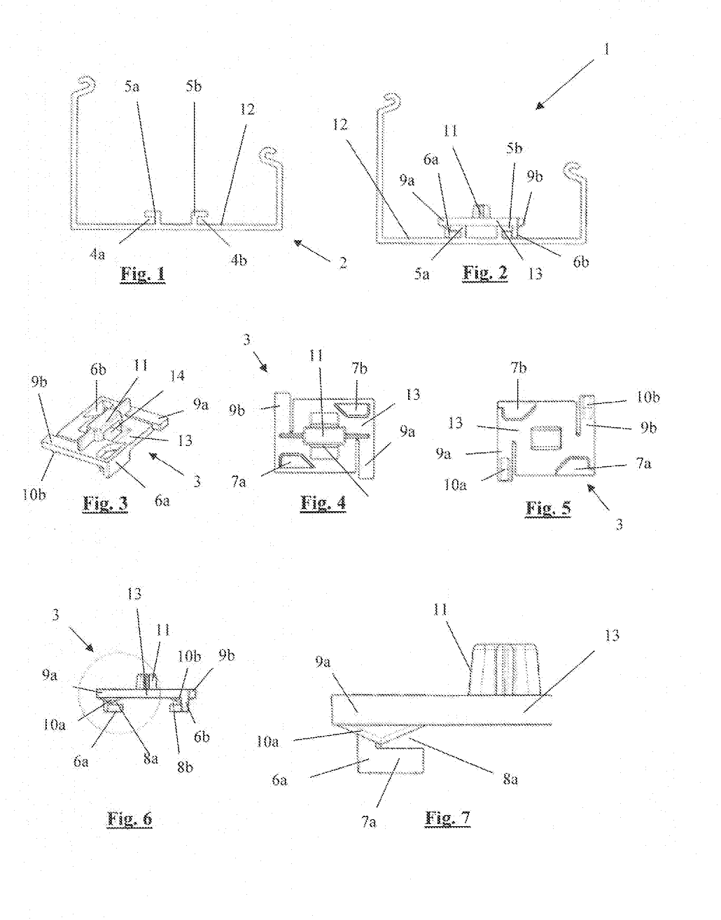

### DETAILED DESCRIPTION OF THE DRAWINGS

The invention will now be described in greater depth based on the following detailed description of an embodiment of a mounting system according to this invention. The purpose of this description is to give illustrative examples and to indicate further advantages and special features of a preferred embodiment according to this invention and should not be interpreted as a limitation of the scope of the application of the invention or of the patent rights requested in the claims. This detailed description employs reference numerals to refer to the appended drawings.

An embodiment of the mounting system (1) according to the invention is illustrated in the figures. The mounting system (1) comprises a duct (2) and a mounting element (3) and it is suitable for mounting tubes of a climatization device or a refrigeration device. The mounting system (1) is designed to be attached to a surface, preferably a wall. The mounting system (1) can however also be located inside a wall. The tubes of the climatization device or a refrigeration device are connected to the mounting system (1) by connecting the tubes by means of one or several cable ties to the mounting element (3).

The duct (2) comprises a bottom (12) and a first and a second protrusion (5a, 5b) which extend over the entire length of the duct (2). These protrusions (5a, 5b) are located at a certain distance from each other and run parallel to each other. The protrusions (5a, 5b) are L-shaped beams (5a, 5b) comprising flanges and said flanges are directed away from each other. Further the duct (2) comprises a first and a second substantially U-shaped mounting channel (4a. 4b), in which said mounting channels (4a. 4b) are respectively located between the bottom (12) and the first protrusion (5a) and between the bottom (12) and the second protrusion (5b).

The mounting element (3), which is detachably connectable to the duct (2), comprises a cuboid shaped base (13), a first and a second protruding connecting part (6a, 6b) protruding form said base (13) wherein these connecting parts (6a, 6b) are located at opposite sides of the mounting element (3) as far apart as possible. Each connecting part (6a, 6b) comprises a flange (7a, 7b), wherein the cross section of the flanges (7a, 7b) of the connecting parts (6a, 6b), parallel with respect to the base (13), have substantially a right-angled trapezoidal shape.

The mounting element (3) also comprises a first and a second mounting gutter (8a, 8b) which are respectively enclosed between the first protruding connecting part (6a) and the base (13) and between the second protruding connecting part (6b) and the base (13).

The mounting element (3) further comprises two blocking element (9a, 9b) for blocking the mounting element (3), wherein these blocking elements (9a, 9b) are movably connected to the base (13) as such that each blocking element (9a, 9b) is movable from a home position to a second position with respect to the base (13), wherein each blocking element (9a, 9b) comprises a projection (10a, 10b), located on the same side of the mounting element (3) as the connecting parts (6a, 6b). These blocking elements (9a. 9b) are located at opposite sides of the mounting element (3) as far away as possible and at opposite sides of the connecting parts (6a, 6b). The home position is substantially located within the plane of the base (13) of the mounting element (3).

The mounting element (3) also comprises a knob (11) to turn the mounting element (3) substantially parallel with respect to the bottom (12) of the duct (2) and the mounting element (3) is created as one piece by means of injection molding. The shape of the mounting element (3) ensures that the blocking elements (9a, 9b) are elastically movable with respect to the base (13). The mounting element (3) further comprises an opening (14) for connecting the tubes of a climatization device or a refrigeration device by means of cable ties.

The mounting element (3) is detachably connected to the duct (2). When the mounting element (3) is connected to the duct (2), when it is in its first position, the flange (7a) of the first connecting part (6a) of the mounting element (3) is partially located inside the first mounting channel (4a), the flange (7b) of the second connecting part (6b) of the mounting element (3) is partially located inside the second mounting channel (4b), the flange of the first protrusion (5a) is partially located inside the first mounting gutter (5a) and the flange of the second protrusion (5b) is partially located inside the second mounting gutter (8b). Thus, the protrusions (5a, 5b) and the connecting parts (6a, 6b) interlock, creating thus a strong connection between the duct (2) and the mounting element (3). The blocking elements (9a. 9b) further strengthen this connection. The way they do this is further explained.

To disconnect the mounting element (3) form the duct (2), the mounting element (3) can be turned, substantially parallel with respect to the bottom (12) of the duct (2), from its first position to a second position, wherein the mounting element (3) can be detached from the duct (2). The mounting element (3) is turnable with respect to the duct (2), substantially parallel with respect to the bottom (12) of the duct (2), because the shape of the flanges (7a, 7b) of the connecting parts (6a, 6b) allow this movement. In the first position of the mounting element (3) the parallel sides of the right-angled trapezoidal cross section of the flanges (7a, 7b) of the connecting parts (6a, 6b), run substantially parallel to the mounting channels (4a, 4b). The U-shaped mounting channels (4a, 4b) are practically completely filled at the level of the flanges (7a, 7b), by the flanges (7a, 7b). Only between the lateral sides and the protrusions (5a, 5b) some room is left. Because of this room the mounting element (3) is able to turn with respect to the duct (2). During the turning from the first position to the second position of the mounting element (3), the flanges (7a, 7b) turn away from the mounting channels (4a, 4b) until the lateral sides of the flanges (7a, 7b) are located just outside the mounting channels (4a, 4b) and are parallel with respect to the mounting channels (4a. 4b). The mounting element (3) can now be detached from the duct (2).

The blocking elements (9a, 9b) are able to block the mounting element (3) in its first position because to turn the mounting element (3) from its second position to its first position, the projections (10a, 10b) must slide over the protrusions (5a, 5b), thereby at first pushing the blocking elements (9a, 9b) upwards form their home position to their second position, and afterwards the blocking elements (9a, 9b) return to their home position, as such blocking the mounting element (3). A certain force is therefore needed to turn the mounting element (3). Therefore the connecting between the mounting element (3) and the duct (2) cannot just loosen during the use of the mounting system (1). Human intervention is able to provide the required force. With human intervention the mounting element (3) can be connected to and disconnected from the duct (2).

The mounting element (3) is also slidable with respect to the duct (2). Therefore the mounting element (3) can be slid to its desired position with respect to the duct (2) after it is already connected to the duct (2) and also the mounting element (3) can be connected and disconnected by sliding the mounting element (3).

Preferably several mounting elements (3) are connected to one duct (2) and commonly several ducts (2) are fitted next to each other against a surface. After the ducts (2) are fitted against a surface, the mounting elements (3) can still be connected.

Preferably several mounting elements (3) are connected to one duct (2) and commonly several ducts (2) are fitted next to each other against a surface. After the ducts (2) are fitted against a surface, the mounting elements (3) can still be connected and disconnected to the ducts (2), without the need to remove one or several ducts (2).

1. A mounting system for mounting tubes of a climatization device or a refrigeration device comprising a section and a mounting element for fixating the tubes to the mounting system wherein the section comprises
a bottom;
at least one protrusion protruding from said bottom;
a first and a second mounting channel, in which said mounting channels are at least partially delimited by a said protrusion;
wherein the mounting element is detachably connectable to the section,
wherein the mounting element comprises
a base;
a first and a second protruding connecting part protruding form said base;
wherein each connecting part comprises a flange for detachably connecting the mounting element to the section, wherein, when the mounting element is connected to the section, the first and the second flange of the mounting element are respectively at least partially located inside said first and said second mounting channel and wherein the mounting element is turnable, substantially parallel with respect to the bottom of the section, from a first position to a second position and vice versa, in which in the first position, the flanges of the mounting element are at least partially located inside the mounting channels, and the mounting element is connected to the section and in which in the second position, the flanges of the mounting element are located outside the mounting channels as such to allow the mounting element to be detached from the section.

2. A mounting system as in claim 1, wherein the mounting element comprises a first and a second mounting gutter which are respectively enclosed between the first protruding connecting part and the base and between the second protruding connecting part and the base, and the section comprises at least two protrusions, wherein each protrusion comprises a flange wherein, in the first position of the mounting element, the flange of the first protrusion is partially located inside the first mounting gutter and the flange of the second protrusion is partially located inside the second mounting gutter.

3. A mounting system as in claim 1, wherein the mounting element comprises a first and a second mounting gutter which are respectively enclosed between the first protruding connecting part and the base and between the second protruding connecting part and the base, and the protrusion comprises two flanges, wherein in the first position of the mounting element, the first flange of the protrusion is partially located inside the first mounting gutter and the second flange of the protrusion is partially located inside the second mounting gutter.

4. A mounting system as in claim 1, wherein the first and the second mounting channel extend in the longitudinal direction of the section, run substantially parallel to each other and wherein each mounting channel has the same cross section, perpendicular to said longitudinal direction, throughout its entire length.

5. A mounting system as in claim 4, wherein the cross section of the flanges of the connecting parts, parallel with respect to the base, have substantially a trapezoidal shape as such that when the mounting element is in its first position, the parallel sides of said trapezoid run substantially parallel to the mounting channels and as such that when the mounting element is in its second position the lateral side of said trapezoid closest to a said mounting channel runs substantially parallel to the mounting channels.

6. A mounting system as in claim 1, wherein the flanges of the connecting parts are located at opposite sides of the mounting element as far apart as possible.

7. A mounting system as in claim 3, wherein the protrusion is a T-shaped beam which extends in the longitudinal direction of the section.

8. A mounting system as in claim 2, wherein the section comprises two protrusions at a certain distance from each other and parallel with each other, which are L-shaped beams and which extend in the longitudinal direction of the section.

9. A mounting system as in claim 1, wherein the section is a duct.

10. A mounting system as in claim 1, wherein the mounting element comprises a blocking element for blocking the mounting element, which is movably connected to the base as such that the blocking element is movable from a home position to a second position with respect to the base, wherein this blocking element comprises a projection, located on the same side of the mounting element as the connecting parts as such that during the turning of the mounting element from its second position to its first position, the projection slides over the protrusion, thereby at first pushing the blocking element upwards form its home position to is second position, and afterwards the blocking element returns to its home position as such blocking the mounting element in its first position.

11. A mounting system according to claim 10, wherein the mounting element comprises two blocking elements at opposite sides of the mounting element as far away as possible.

12. A mounting system according to claim 1, wherein the tubes are connected to the mounting element by a cable tie.

13. A mounting system according to claim 1, wherein that the mounting element is slidable with respect to the protrusion.

14. A mounting system, according to claim 1, wherein the mounting element is created as one piece.

15. Mounting system according to claim 1, wherein
the mounting element comprises a first and a second mounting gutter which are respectively enclosed between the first protruding connecting part and the base and between the second protruding connecting part and the base;
the section is a duct which comprises two protrusions at a certain distance from each other and parallel with each other, which are L-shaped beams and which extend in the longitudinal direction of the section, wherein each protrusion comprises a flange wherein, in the first position of the mounting element, the flange of the first protrusion is partially located inside the first mounting gutter and the flange of the second protrusion is partially located inside the second mounting gutter;
wherein the cross section of the flanges of the connecting parts, parallel with respect to the base, have substantially a trapezoidal shape as such that when the mounting element is in its first position, the parallel sides of said trapezoid run substantially parallel to the mounting channels and as such that when the mounting element is in its second position the lateral side of said trapezoid closest to a said mounting channel runs substantially parallel to the mounting channels
wherein the flanges of the connecting parts are located at opposite sides of the mounting element as far apart as possible;
wherein the mounting element comprises two blocking elements, at opposite sides of the mounting element as far away as possible and at opposite sides of the connecting parts, for blocking the mounting element, which is movably connected to the base as such that each blocking element is movable from a home position to a second position with respect to the base, wherein each blocking element comprises a projection, located on the same side of the mounting element as the connecting parts as such that during the turning of the mounting element from its second position to its first position, the projections slide over the protrusion, thereby at first pushing the blocking elements upwards form their home position to their second position, and afterwards the blocking elements return to their home position as such blocking the mounting element in its first position;
the tubes are connected to the mounting element by a cable tie.
